(19) United States
(12) Patent Application Publication
(10) Pub. No.: US 2022/0319323 A1
(43) Pub. Date: Oct. 6, 2022

(54) METHOD FOR IDENTIFYING ROAD RISK BASED ON NETWORKED VEHICLE-MOUNTED ADAS

(71) Applicant: WUHAN UNIVERSITY OF TECHNOLOGY, Hubei (CN)

(72) Inventors: NENGCHAO LV, HUBEI (CN); TUO JI, HUBEI (CN); CHAOZHONG WU, HUBEI (CN); JIAQIANG WEN, HUBEI (CN)

(73) Assignee: WUHAN UNIVERSITY OF TECHNOLOGY, HUBEI (CN)

(21) Appl. No.: 17/527,009

(22) Filed: Nov. 15, 2021

(30) Foreign Application Priority Data
Apr. 1, 2021 (CN) 202110356440.0

(51) Int. Cl. G08G 1/16; G06K 9/62; G08G 1/01

(52) U.S. Cl. CPC G08G 1/16; G06K 9/6223; G08G 1/0133; G08G 1/0129; G08G 1/0112

(57) ABSTRACT

The invention discloses a method for identifying a road risk based on a networked vehicle-mounted ADAS, including a construction of a road risk classification system and regional road risk identification, and the following steps: step S1: collecting networked ADAS sensing data, extracting time-to-collision, and braking deceleration; step S2: establishing two-dimensional comprehensive risk indicators, performing clustering, and building a road risk classification system based on clustering results; step S3: establishing a scoring system; step S4: selecting regional roads, divide the regional roads into different sections, and obtaining the two-dimensional comprehensive risk indicators corresponding to each section; step S5: matching the two-dimensional comprehensive risk indicators section with the road risk grade classification system to obtain the frequency of different road risk grades for each road section; step S6: combining with the scoring system. The invention can complete the urban road operation risk assessment faster, more efficiently and at a lower cost.

### CROSS-REFERENCE TO RELATED APPLICATION

This application claims the priority benefit of China application serial no. 202110356440.0 filed on Apr. 1, 2021. The entirety of the above-mentioned patent application is hereby incorporated by reference herein and made a part of this specification.

### BACKGROUND

### Technical Field

The disclosure relates to the field of traffic safety and intelligent transportation, particularly a method for identifying road risk based on a networked vehicle-mounted ADAS.

### Description of Related Art

In recent years, with the process of urbanization has accelerated, urban road traffic accidents have occurred frequently, and the number of traffic deaths and traffic accidents has increased year by year, seriously threatening the lives and property safety of Chinese residents. Therefore, identifying urban road operation risks and real-time knowledge of road risk levels are of great significance for taking reasonable road traffic control measures.

Generally speaking, the basis of road risk identification can be considered from the factors affecting traffic safety, but this method is too subjective and the estimated result is unreliable. With the development of the Internet of Vehicles technology, the use of on-board GPS data of operating vehicles combined with methods such as analytic hierarchy process, probability statistics, fuzzy analysis, and other methods to assess urban road risks has become the mainstream method, but this method often requires a large amount of data, And the accuracy needs to be improved. Therefore, judging from the existing road risk assessment methods, there is still a lack of a method that can complete urban road operation risk assessment quickly, efficiently and at a lower cost.

At present, ADAS has been gradually applied to cars and various special vehicles, and the large amount of data it senses provides a new data source for urban road risks. With the help of sensors installed on the vehicle, ADAS vehicles can continuously sense the surrounding environment during driving. Through the identification, detection and tracking of dynamic and static objects, the ADAS system can collect rich motion information in real time. Based on the perception information of ADAS vehicles, key information can be further extracted to complete the identification of road risk levels.

### SUMMARY

In order to solve the above technical problems, the present invention provides a road risk identification method based on connected vehicle ADAS, which solves the problem of large data acquisition volume and cost of the existing vehicle network technology road risk identification and evaluation methods, and the problem of insufficient speed and efficiency if the standards are not unified. Provide a low-cost, fast and efficient road risk identification method based on connected vehicle ADAS.

The technical scheme provided by the present invention is as follows:

step 1: A road risk classification system, which comprises the following steps:

step S1: use ADAS vehicles to collect alternative safety indicators (TTC, ax);

step S2: establish a two-dimensional risk evaluation index system, and perform cluster analysis on a large number of (TTC, ax) data sets;

step S3: establish a scoring system based on the frequency and severity of road risk events at various levels; step 2: A regional road risk identification system consists, which comprises the following steps:

step S4: Select regional roads, divide the regional roads into different sections, and obtain the two-dimensional comprehensive risk indicators corresponding to each section;

step S5: Match the two-dimensional comprehensive risk index of each road section with the road risk grade classification system to obtain the frequency of different road risk grades for each road section;

step S6: Combined with the scoring system, the road risk of each road section is determined based on the scoring results. Preferably, acquiring the two-dimensional comprehensive risk index corresponding to each road section specifically includes: acquiring the longitude and latitude information of each road section, and matching and associating the two-dimensional comprehensive risk index with the corresponding road section based on the longitude and latitude information corresponding to the two-dimensional comprehensive risk index.

Especially, according to the map matching algorithm, the two-dimensional comprehensive risk indicator is matched and associated with the corresponding road section.

Preferably, the method further includes: obtaining time stamp information corresponding to the two-dimensional comprehensive risk index, dividing the time stamp information into different time periods, and then determining the road risk of each road section at different time periods.

Preferably, the different time periods include daytime and nighttime.

Preferably, the method for dividing the road risk level division system includes: matching the two-dimensional comprehensive risk index with the cluster center to obtain the corresponding road risk level.

Preferably, before establishing the two-dimensional comprehensive risk index, preprocessing is performed on the extracted collision time (TTC) and braking deceleration (ax).

Preferably, the preprocessing includes data quality analysis and/or data gross error processing.

Preferably, the ADAS perception data includes: collision time TTC, braking deceleration a, longitude and latitude information Li, Bi timestamp information and ADAS vehicle ID.

Preferably, the road risk level includes three levels of low, medium, and high, and different scores are assigned to different road risk levels, and a scoring system is established.

### BRIEF DESCRIPTION OF THE DRAWINGS

FIG. 1 is a flow chart illustrating of a method for identifying road risk based on networked vehicle-mounted ADAS according to an embodiment of the disclosure.

FIG. 2 is a schematic diagram of using an on-board ADAS to extract a substitute safety index according to an embodiment of the disclosure.

FIG. 3 is a schematic diagram illustrating clustering index (TTC, ax) pairs using a clustering method according to an embodiment of the disclosure.

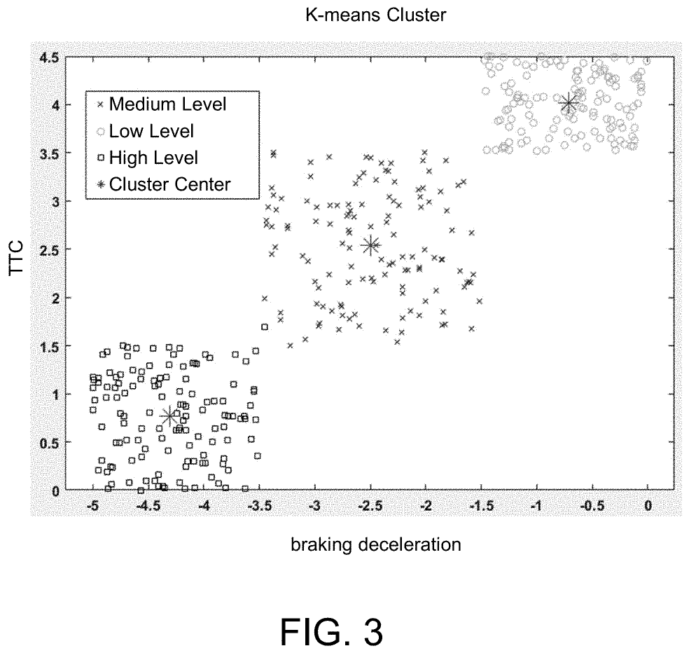

FIG. 4 is a schematic diagram illustrating a road segment division method according to an embodiment of the disclosure.

### DESCRIPTION OF THE EMBODIMENTS

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The main idea of the present invention is: the first step is to complete the construction of the road risk classification system. First, use ADAS vehicles to collect and replace the safety indicators TTC, a, establish a two-dimensional risk evaluation index system, and then use the clustering method to analyze a large number of (TTC, a) The data set clusters and then divides the urban road risk level; the second step is to identify the regional road risk level. First, the map matching algorithm is used to match the alternative safety indicators collected by ADAS vehicles in a certain area to the road sections in the area, and then pass Substitute the two-dimensional variable (TTC, ax) data set to match the constructed road risk classification system, and then determine the operation risk of each road section.

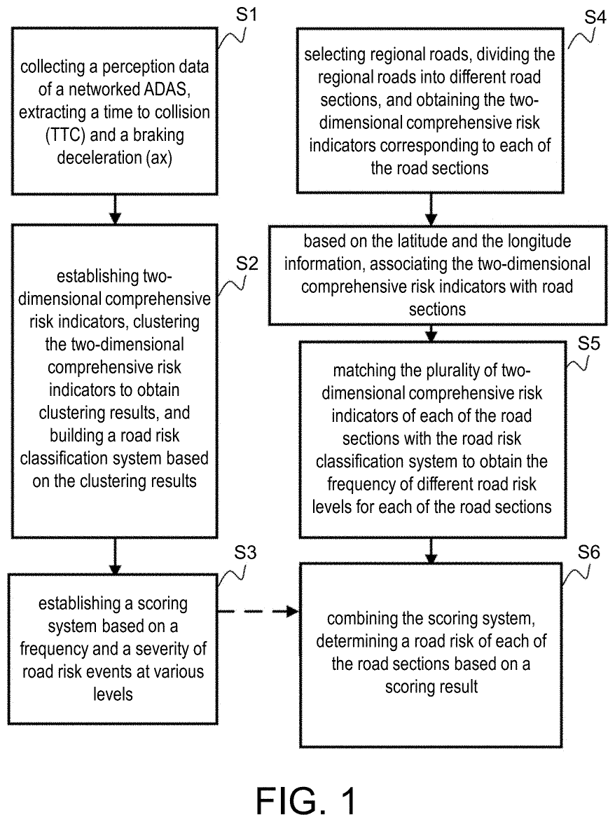

The present invention is a method for identifying a road risk based on a networked vehicle-mounted advanced driver assistance systems (ADAS), as shown in FIG. 1, the method including the following steps.

Step 1: construction of road risk classification system:

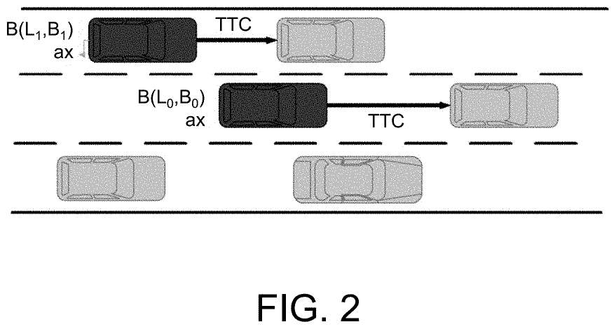

as shown in FIG. 2, first of all, step S1: For the urban road traffic system operating with networked ADAS vehicles, the basic parameters of the motion data perceived by all ADAS vehicles in the system within a certain time range are obtained, and the collision time TTC and the system in each frame of data of the ADAS vehicles are extracted based on the basic parameters of the motion data. Dynamic deceleration a, two key alternative safety indicators;

step S2: Based on the preprocessed TTC and a, the index data, based on the corresponding ADAS vehicle ID and timestamp information, respectively pair and establish a two-dimensional comprehensive risk index (TTC, ax); then use the clustering method to compare the two-dimensional index (TTC, ax) Perform clustering. According to the number of clusters and cluster centers, combined with the degree of risk represented by two-dimensional indicators (TTC, ax), the risk levels corresponding to various risk events are divided into low, medium, and high Level three;

step S3: Count the number of occurrences and severity of risk events of various levels in the selected urban area, assign different scores to events of different risk levels, establish a scoring system, and classify road risk levels.

Step 2: Regional road risk identification:

step S4: According to the road area to be identified and evaluated, the road area is divided into different road sections according to the spatial position relationship. Extract the TTC, ax, longitude and latitude and other information perceived by ADAS vehicles in the area, divide the two-dimensional index (TTC, ax) into two periods of day and night according to the timestamp information, and use a map matching algorithm to divide each frame The longitude and latitude information in the data is associated with the divided road sections; on this basis, the two-dimensional index (TTC, ax) corresponding to each frame of data is associated with the road area divided road sections. Identify risk road sections during the day and night respectively, so as to distinguish the risk factors during the day and night in the subsequent sequence.

Step S5: For each time period and each road section, use its associated two-dimensional indicator (TTC, ax) data set to match the constructed road risk level system, and then determine the risk level of each road section at different time periods, and complete the road section within the selected road area Spatial risk level identification.

Further, in step S1 of the present invention, the specific method for obtaining two alternative safety indicators is as follows:

Select an urban transportation system with ADAS vehicle distribution. When the ADAS vehicle is traveling in the traffic system, it can collect the vehicle movement of the forward target perception information in real time. The types of motion information include time stamp information, ADAS vehicle desensitization flag number, braking deceleration, longitude, latitude, and collision time TTC.

Use the perception data of ADAS vehicles to construct an ADAS database. The ADAS database contains massive, multi-source, long-term and wide-range motion information of ADAS vehicles.

Based on a large amount of data information in the database, extract the TTC and ax in each frame of data, the two major alternative safety indicators, and synchronize the extracted information with the basic information. Basic information includes TTC and ax, time stamp and latitude and longitude information of the frame.

Further, in step S2 of the present invention, the specific method for dividing the road risk level is: completing the preprocessing of the extracted TTC and ax index data. The preprocessing work includes data quality analysis and data gross error elimination, including:

Data quality analysis: For each frame of data extracted, check the values of the variables TTC and ax, delete each frame of data containing invalid values and missing values, and retain each frame of data within a reasonable range;

Data gross error elimination: For each frame of data extracted, check the values of longitude and latitude, and eliminate data frames with drifting phenomenon.

Establish two-dimensional comprehensive risk indicators. For the preprocessed data, the alternative safety indicators TTC and ax are selected as basic variables, and a two-dimensional comprehensive risk indicator (TTC, ax) is constructed from the TTC and ax in each frame of data.

Classification of event risk. According to a large number of established two-dimensional comprehensive risk indicators (TTC, ax), clustering them using clustering methods, to obtain different clusters and cluster centers, including

Determine the number of clusters: According to the expected number of risk classification levels, determine the number of clusters this time as N=3;

Determine the initial clustering center: randomly select 3 initial clustering centers (TTC₁, aₓ₁), (TTC₂, aₓ₂) and (TTC₃, aₓ₃) according to the value range of the alternative safety indicators TTC and a. Based on the matching of each preliminary screening risk event with the cluster center, the events are divided into low, medium, and high.

Complete clustering and risk classification: According to the clustering center and the number of clusters, clustering is completed using a clustering algorithm, and the clustering results are obtained. According to the relationship between the value of (TTC, ax) and the risk, the three clusters obtained are divided into low-risk, medium-risk and high-risk in turn.

Further, a method to establish a road scoring system of step S3 of the present invention particularly is counting the number of occurrences of various risk events in the selected urban area, assign different scores to events of different risk levels, establish a scoring system, and classify road risk levels. Counting the number of various risk levels in the road or area:

| | Risk level | | |
|---|---|---|---|
| | low-risk | medium-risk | high-risk |
| quantity | x | y | z |

All kinds of risks are assigned different scores, a score for low risk, b score for medium risk, and c score for high risk, where a<b<c. Then the total scores of various risk levels in the area are:

Score_{low-risk}=a*x

Score_{medium-risk}=b*y

Score_{high-risk}=c*z

Scoreₐₗₗ=a*x+b*y+c*z

According to the scores of each risk level, a scoring system is established to further divide the road risk level.

The step 2: regional road risk identification and classification, which comprises the following steps

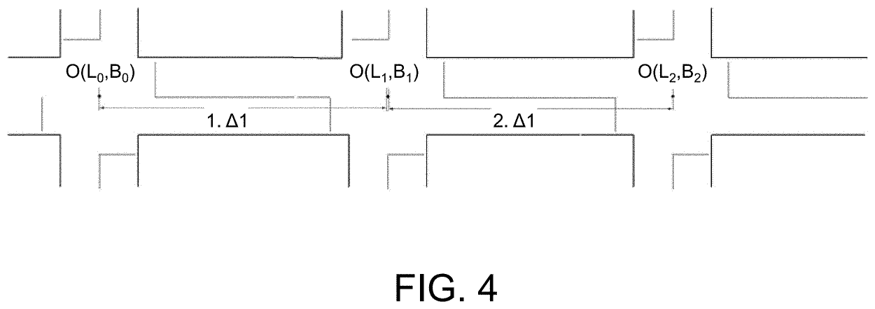

Step S4: selecting the regional roads, dividing the regional roads into different sections, and then extracting the motion information perceived by the ADAS vehicles in the process of traveling in the region. And based on the latitude and longitude information of the ADAS vehicle, the two-dimensional index (TTC, ax) is matched to the section of the road in the area. According to the rules of equal intervals or considering special entrances and exits, the road area is spatially divided into sub-sections. As shown in FIG. 4, the urban area is divided into n road sections based on the principle of adjacent intersections as one road section, and the longitude and latitude information LₙBₙ at the center point O of each intersection is collected, and the actual distance between the two intersections is the length of the road section. Then number the road sections as 1, 2 . . . n in sequence, and the 4 corner points of each road section represent the range of the road section;

Road_{segment}={L₁,L₂,L₃,L₄, . . . Lₙ}

Lᵢ_{_{scope}}={(lonᵢ₁,latᵢ₁),(lonᵢ₂,latᵢ₂),(lonᵢ₃,latᵢ₃),(lonᵢ₄,latᵢ₄),(lonᵢₙ,latᵢₙ)}

For each frame of data extracted, the TTC and ax set Dⱼ is associated with each road section Lᵢ_{_{scope}}. First, the two-dimensional indicators (TTC, ax) are divided into two periods of D_{jday}, D_{jnight} using time stamp information. Then uses a map matching algorithm to associate the longitude and latitude information in each frame of data with the range of the road section; then associate the two-dimensional index (TTC, ax) in Dⱼ with the road section. Each link is associated to obtain m two-dimensional indicators (TTC, ax), which constitute a data set of link-related two-dimensional indicators (TTC, ax).

Match:{(lonⱼ,latⱼ)∈Lᵢ_{_{scope}},i=1, . . . ,n}

Lᵢ={(TTCᵢ₁,aₓᵢ₁),(TTCᵢ₂,aₓᵢ₂), . . . ,(TTCᵢₘ,aₓᵢₘ)}

The step S5: for different time periods and different road sections, each two-dimensional index (TTC, ax) data set is matched with the constructed road risk level system, and then the risk level of each road section in different time periods can be determined, and the risk level identification can be completed. After calculating the associated two-dimensional index data set of each road section, it is matched with the divided road risk level to obtain the number of low and high risks in each road section at each time period, and each risk frequency is recorded in turn. Take the risk frequency of different road sections during the daytime as an example;

| Road section | 1 | 2 | 3 | . . . | n |
|---|---|---|---|---|---|
| low-risk times | x₁ | x₂ | x₃ | . . . | xₙ |
| medium-risk times | y₁ | y₂ | y₃ | . . . | yₙ |
| high-risk times | z₁ | z₂ | z₃ | . . . | zₙ |

The step S6: through the scoring method, the low risk is given a score, the medium risk is given a b score, and the high risk is given a c score, where a<b<c, then the total risk score of a certain road section i is:

R=a*xᵢ+b*yᵢ+c*zᵢ

Based on the total risk score of each road section at different times, the final specific risk level of each road section is determined through the value relationship between the total risk score and the risk level.

In summary, the present invention discloses a road risk classification and identification method based on the extraction of alternative safety indicators based on the Advanced Driver Assistant System (ADAS) on-board safety. The method can be divided into road risk classification system construction and There are two key steps to identify the risk level of regional roads. (1) Construction of the road risk classification system: First, use the Internet of Vehicles technology to collect a large number of on-board sensor information installed with networked ADAS in the road area, and use ADAS to extract the time to collision (TTC) and brake reduction in the on-board data. Braking deceleration ax is the two key alternative safety indicators; then, the TTC and ax indicators are used to establish a two-dimensional comprehensive risk assessment indicator (TTC, ax); finally, a large number of two-dimensional indicator (TTC, ax) data sets are analyzed using the clustering method. Clustering, the cluster center of each type of risk event is obtained, and the event risk level is divided into low, medium, and high. (2) Regional road risk level identification: First, extract the TTC, ax, and the corresponding longitude, latitude, time stamp and other information perceived by the ADAS in the area for a certain road area where risk identification is to be carried out; secondly, the road area is fixed according to The principle is divided into different road sections and numbered; then, the two-dimensional index (TTC, ax) is matched and associated with the road section in the selected area using the longitude and latitude information sensed by the ADAS vehicle; then, for each road section, the two-dimensional index (TTC, ax) The data set is matched with the constructed road risk classification system; finally, the risk level of each road section is determined through the combination of the frequency and severity of risk events in the road section, and the spatial risk level identification in the selected road area is completed. The invention uses a large number of alternative safety index data collected by the networked ADAS to complete the road risk level classification, and can identify the risk level of the selected actual road, can accurately and real-time reflect the road traffic safety status, and has a certain effect on improving the traffic safety of the road section. significance.

What is claimed is:

1. A method for identifying a road risk based on a networked vehicle-mounted advanced driver assistance systems (ADAS), the method comprises the following steps:
step 1: construction of road risk classification system, which comprises the following steps:
step S1: collecting a perception data of a networked ADAS, extracting a time to collision (TTC) and a braking deceleration (ax);
step S2: establishing two-dimensional comprehensive risk indicators, clustering the two-dimensional comprehensive risk indicators to obtain clustering results, and building a road risk classification system based on the clustering results;
step S3: establishing a scoring system based on a frequency and a severity of road risk events at various levels;
step 2: regional road risk identification, which comprises the following steps:
step S4: selecting regional roads, dividing the regional roads into different road sections, and obtaining the two-dimensional comprehensive risk indicators corresponding to each of the road sections;
step S5: matching the plurality of two-dimensional comprehensive risk indicators of each of the road sections with the road risk classification system to obtain the frequency of different road risk levels for each of the road sections;
step S6: combining the scoring system, determining a road risk of each of the road sections based on a scoring result.

2. The method according to claim 1, wherein the step of obtaining the two-dimensional comprehensive risk indicators corresponding to each of the road sections comprises: obtaining a longitude and a latitude information of each of the road sections, based on the latitude and the longitude information corresponding to the two-dimensional comprehensive risk indicators, the two-dimensional comprehensive risk indicators are matched and associated with the corresponding road sections.

3. The method according to claim 2, wherein the plurality of two-dimensional comprehensive risk indicators are matched and associated with the corresponding road sections according to a map matching algorithm.

4. The method according to claim 1, wherein the method further comprises: obtaining a plurality of time stamp information corresponding to the two-dimensional comprehensive risk indictors, and dividing the plurality of time stamp information into different time periods so as to determine the road risk of each of the road sections at the different time periods.

5. The method according to claim 4, wherein the different time periods include daytime and nighttime.

6. The method according to claim 1, wherein a classification method of the road risk classification system includes: matching the two-dimensional comprehensive risk indicators with clustering centers to obtain corresponding road risks grade.

7. The method according to claim 1, wherein before establishing the two-dimensional comprehensive risk indicators, the extracted time to collision (TTC) and the braking deceleration (ax) are preprocessed by a preprocessing step.

8. The method according to claim 7, wherein the preprocessing step includes data quality analysis and/or data gross error processing.

9. The method according to claim 1, wherein the perception data of the networked ADAS includes: the time to collision (TTC), the braking deceleration (ax), the longitude (Lᵢ) and the latitude information (Bᵢ), the plurality of time stamp information, and a ADAS Vehicle ID.

10. The method according to claim 1, wherein the different road risk levels include three levels, which are low, medium and high, and the different road risk levels are assigned different scores to establish a scoring system.
